(19) United States
(12) Patent Application Publication
(10) Pub. No.: US 2005/0002174 A1
(43) Pub. Date: Jan. 6, 2005

(54) Light guide panel with optical deflector and edge-light type backlight system

(75) Inventors: Jee-hong Min, Yongin-si (KR); Hwan-young Choi, Yongin-si (KR); Moon-gyu Lee, Suwon-si (KR); Jin-hwan Kim, Suwon-si (KR); Jin-seung Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/824,648

(22) Filed: Apr. 15, 2004

(30) Foreign Application Priority Data
Apr. 15, 2003 (KR) P2003-23730

(51) Int. Cl. F21V 8/00

(52) U.S. Cl. 362/31

(57) ABSTRACT

An edge-light type backlight system including a light guide panel which includes a light incident surface, a light emitting surface, and an optical deflector. The optical deflector is disposed on at least one of the light emitting surface of the light guide panel and a surface opposite to the light emitting surface. The optical deflector includes a first surface and a second surface on opposite sides of a normal line orthogonal to the light incident surface and become farther apart as distance from the light incident surface increases, the first surface and the second surface being perpendicular to the light emitting surface.

### BACKGROUND OF THE INVENTION

This application claims the priority of Korean Patent Application No. 2003-23730, filed on Apr. 15, 2003, with the Korean Intellectual Property Office, the disclosure of which is incorporated herein in its entirety by reference.

1. Field of the Invention

The present invention relates to a backlight system, and more particularly, to an edge-light type backlight system using a light guide panel and a rod-shaped light source.

2. Description of the Related Art

Backlight systems are mainly used in non-emissive flat panel displays (FPDs), such as liquid crystal displays (LCDs), to ensure proper luminance or brightness. Backlight systems are classified according to arrangement of light sources as direct-light type backlight units, in which a light source is installed under an FPD to directly emit light to FPD, and edge-light type backlight units, in which a light source is installed along an edge surface of a light guide panel to emit light through the light guide panel to an FPD.

Edge-light type backlight systems can use both a rod-shaped light source and a point light source. As a representative rod-shaped light source, there is a cold cathode fluorescent lamp (CCFL) which consists of a tube with electrodes at both ends thereof. As a representative point light source, there is a light emitting diode (LED). CCFLs have many advantages, such as being able to emit strong white light, obtain high luminance and uniformity, and being applied to large FPDs.

FIG. 1 is a schematic perspective view of a related art edge-light type backlight system using a rod-shaped light source, and FIG. 2 is a plan view of the related art edge-light type backlight system of FIG. 1.

Referring to FIG. 1, a CCFL 20 is installed at an edge surface 13 of a light guide panel 10. An optical path-changing unit 30 is disposed on a bottom surface 11 of the light guide panel 10 to change an optical path for the purpose of emitting light introduced from the CCFL 20 through a light emitting surface 12.

A rod-shaped light source can be considered as a continuum of point light sources. Thus, as shown in FIG. 2, light is emitted from the CCFL 20 within a range of angles A1 of ±90 degrees and enters into the light guide panel 10 through the edge surface 13. In the case of light traveling inside the light guide panel 10, when an angle formed between light incident on a surface within the light guide panel 10 and a normal line of the surface, known as the angle of incidence, is smaller a critical angle, the light passes through the surface. Otherwise, the light is totally reflected. Through repeated reflection, the light can propagate throughout the light guide panel 10.

In order to emit light through the light emitting surface 12, the angle at which light is incident on the light emitting surface 12 should be smaller than a critical angle. Among light rays introduced into the light guide panel 10, light rays which have been totally reflected once cannot pass through the light guide panel 10 to be discharged, unless their path is changed. The optical path-changing unit 30 changes the path along which light travels through scattering, diffraction, etc., so that light can pass through the light emitting surface 12.

In the event that a holographic pattern is used as the optical path-changing unit 30 to diffract light and change the path of the light, diffraction is most efficient when the light is introduced to the holographic pattern while forming an angle of about 90 degrees with respect to the holographic pattern. The smaller the angle distribution of light incident on the holographic pattern, more uniform the brightness of the light emitting surface 12. When the brightness is not uniform, a screen of an FPD (not shown) illuminated by the backlight system suffers unevenness in brightness.

Japanese Patent Publication No. 11-144514 discloses a lighting apparatus using a rod-shaped light source in which a light guide panel includes a plurality of light guide parts to improve brightness over a light emitting surface of the light guide panel.

### SUMMARY OF THE INVENTION

The present invention provides a light guide panel using an optical deflector, which deflects light traveling inside the light guide panel to reduce a range of direction angles, and an edge-light type backlight system employing the same.

According to an aspect of the present invention, there is provided an edge-light type backlight system comprising a light guide panel including a light incident surface into which light enters and a light emitting surface from which light is emitted. The system further includes a rod-shaped light source which projects light to the light incident surface; and a polyhedral optical deflector made of, for example, a transparent material and including a first surface and a second surface, the first surface and the second surface on opposite sides of a normal line orthogonal to the light incident surface and being more distant from each other as distance from the light incident surface increases, wherein the optical deflector is disposed on at least one of the light emitting surface and a surface opposite to the light emitting surface.

A plurality of optical deflectors may be arranged along the light incident surface. Further, the optical deflector may have the same refractive index as the light guide panel. In this case, the optical deflector may be integrally formed with the light guide panel.

The first and the second surfaces may be symmetrical about the normal line orthogonal to the light incident surface.

The first and second surfaces may also be extended to a predetermined position between the light incident surface and the surface opposite to the light incident surface, and may be extended up to the surface opposite to the light incident surface.

A cross-section of the optical deflector in parallel to the light incident surface may be in the shape of a square.

A cross-section of the optical deflector in parallel to the light emitting surface may be in the shape of a triangle whose oblique sides are the first and second surfaces and bottom surface is opposite to the light incident surface. A cross-section of the optical deflector in parallel to the light emitting surface may be in the shape of a trapezoid whose oblique sides are the first and second surfaces and bottom side is opposite to the light incident surface.

According to another aspect of the present invention, there is provided a light guide panel of an edge-light type backlight system using a rod-shaped light source, the light guide panel comprising a light incident surface into which light enters, a light emitting surface from which light is emitted, and an optical deflector protruding from at least one of the light emitting surface and a surface opposite to the light emitting surface. A cross-section of the optical deflector in parallel to the light emitting surface may be in the shape of a triangle whose bottom side is a surface opposite to the light incident surface, the triangular cross-section being extended in a direction perpendicular to the light emitting surface.

A plurality of optical deflectors may be arranged along the light incident surface. Further, a cross-section of the optical deflector in parallel to the light emitting surface may be in the shape of an isosceles triangle.

According to still another aspect of the present invention, there is provided a light guide panel of an edge-light type backlight system using a rod-shaped light source, the light guide panel comprising a light incident surface into which light enters, a light emitting surface from which light is emitted, and an optical deflector protruding from at least one of the light emitting surface and a surface opposite to the light emitting surface. A cross-section of the optical deflector in parallel to the light emitting surface may be in the shape of a trapezoid whose bottom side is a surface opposite to the light incident surface, the trapezoid-shaped cross-section being extended in a direction perpendicular to the light emitting surface.

A plurality of optical deflectors may be arranged along the light incident surface. A cross-section of the optical deflector in parallel to the light emitting surface may be in the shape of an isosceles trapezoid.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic perspective view of a related art edge-light type backlight unit using a rod-shaped light source;

FIG. 2 is a plan view of the related art edge-light type backlight unit of FIG. 1;

FIG. 3 is a perspective view of an edge-light type backlight system according to an exemplary embodiment of the present invention;

FIG. 4 is a sectional view taken along the line I-I′ in FIG. 3;

FIG. 5 is a sectional view taken along the line II-II′ in FIG. 3;

FIG. 6 is a plan view for explaining the operation of the edge-light type backlight unit of FIG. 3;

FIG. 7 is a side view for explaining the operation of the edge-light type backlight unit of FIG. 3;

FIG. 8 is a graph illustrating the distribution of light emitted at an opposite surface when an optical deflector is not used, according to a simulation;

FIGS. 9 and 10 are graphs illustrating the distribution of light emitted at the opposite surface when an angle between the first and second surfaces of the optical deflector and a normal line orthogonal to the light incident surface is changed, according to simulations;

FIGS. 11 and 12 are graphs illustrating the distribution of light emitted at the opposite surface when a thickness of the optical deflector is changed, according to simulations;

FIG. 13 is a graph illustrating the distribution of light emitted from a light guide panel when the optical deflector is not used, according to a simulation;

FIG. 14 is a graph illustrating the distribution of light emitted from the light guide panel when the optical deflector is used, according to a simulation;

FIGS. 15 to 18 are plan views of modified examples of the edge-light type backlight unit of FIG. 3; and

FIG. 19 is a perspective view of an edge-light type backlight unit according to another exemplary embodiment of the present invention.

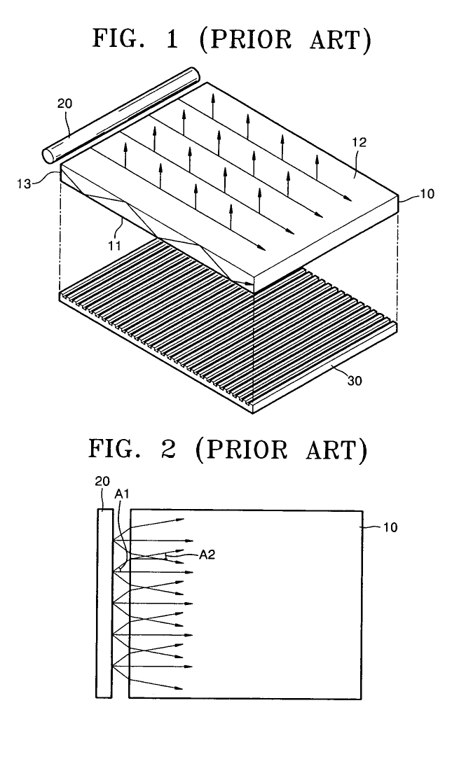

### DETAILED DESCRIPTION OF THE INVENTION

The present invention will now be described more fully with reference to the accompanying drawings, in which exemplary embodiments of the invention are shown.

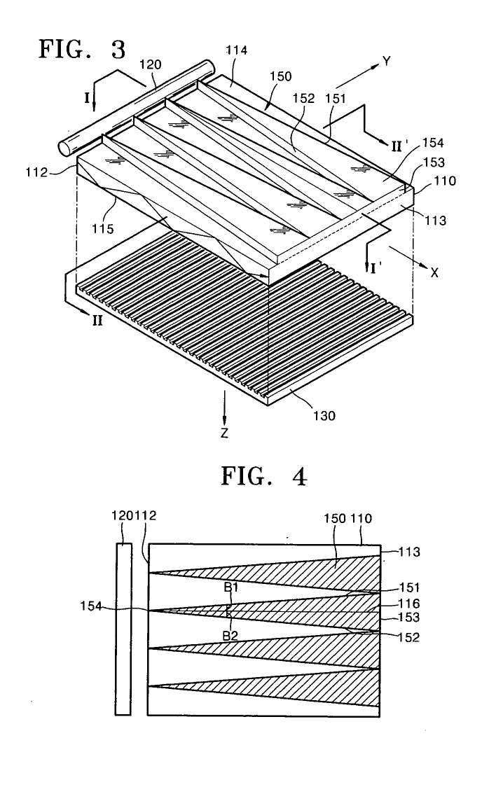

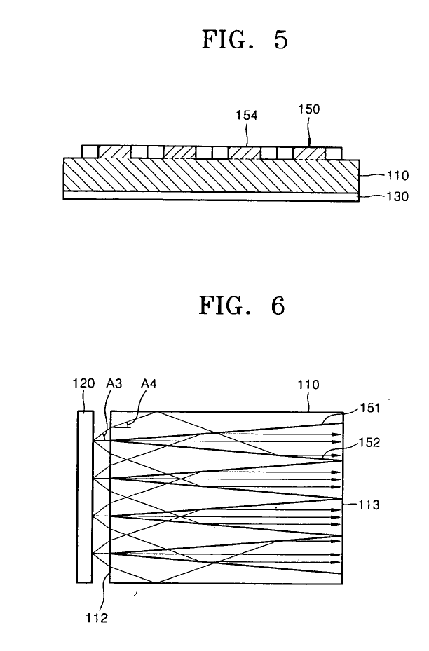

FIG. 3 is a perspective view of an edge-light type backlight system according to an exemplary embodiment of the present invention, FIG. 4 is a sectional view taken along the line I-I′ in FIG. 3, and FIG. 5 is a sectional view taken along the line II-II′ in FIG. 3.

Referring to FIGS. 3 to 5, a light guide panel 110 has a flat panel shape. A cold cathode fluorescent lamp (CCFL) 120 is installed at an edge surface 112 of the light guide panel 110. A plurality of optical deflectors 150 are arranged at a top surface 114 of the light guide panel 110. An optical path-changing unit 130 is disposed on a bottom surface 115 of the light guide panel 110.

The light guide panel 110 is made of a transparent material. In general, the light guide panel 110 is made of a transparent acrylic resin having a refractive index of 1.49 and a specific gravity of 1.19. To reduce weight, a transparent olefinic resin having a specific gravity of 1.0 can be used for the light guide panel as well. The light guide panel 110 according to an exemplary embodiment of the present invention is made of polymethylmethacrylate (PMMA). The light guide panel 110 has a thickness ranging from 1 to 3 mm. To reduce weight, the light guide panel 110 may have a wedge shape which becomes thinner with distance from the edge surface 112 to which light is introduced. The size of the light guide panel 110 is dependent on the size of a flat panel display (not shown), for example, a liquid crystal display (LCD).

Hereinafter, the edge surface 112 will be referred to as a light incident surface 112 onto which light emitted from the CCFL 120 is incident. A light emitting surface from which light is emitted becomes either or both of the top surface 114 and the bottom surface 115. In the present embodiment, the bottom surface 115 will be taken as the light emitting surface and referred to as the light emitting surface 115 hereinafter.

FIG. 4, a cross-section of the optical deflector 150 in parallel to the light emitting surface 115, shows a series of triangles. The optical deflectors 150 each include a first surface 151 and a second surface 152 at opposite sides of a normal line 116 orthogonal to the light incident surface 112. The first and second surfaces 151 and 152 are perpendicular to the light emitting surface 115. The distance between the first surface 151 and the second surface 152 increases as distance from the light incident surface 112 toward the opposite surface 113 increases. An angle between the first surface 151 and the normal line 116 is indicated as B1 and an angle between the second surface 152 and the normal line 116 is indicated as B2. As shown in FIG. 2, since light emitted from an emissive point on the CCFL 120 is generally symmetrical about an optical axis, the angles B1 and B2 are preferably equal. That is to say, the first surface 151 and the second surface 152 are preferably symmetrical about the normal line 116. In this case, a cross-section of the optical deflector 150 in parallel to the light emitting surface 115 is in the shape of a series of isosceles triangles. As shown in FIG. 5, a cross section of the optical deflector 150 in parallel to the light incident surface 112 shows squares. Preferably, a third surface 154 opposing the light emitting surface 115 is parallel to the light emitting surface 115.

The optical deflectors 150 made of a transparent material may be coupled with the light guide panel 110. In this case, it is preferable that the optical deflectors 150 are made of a material having the same refractive index as the light guide panel 110 so that a critical angle of the optical deflector 150 is identical to that of the light guide panel 110. It is more preferable that the optical deflectors 150 are integrally formed with the light guide panel 110.

While four optical deflectors 150 are arranged along the light incident surface 112 in the present embodiment, the number of optical deflectors 150 is not limited to four and may be more than four or less than four in alternative embodiments.

In order to emit light through the light emitting surface 115, an angle of light incident on the light emitting surface 115 with respect to a normal line orthogonal to the light emitting surface 115, which is referred to as the “incident angle” hereinafter, should be smaller than a critical angle. Thus, among light propagating through the light guide panel 110, light which has been totally reflected once cannot be emitted from the light guide panel 110 unless the path thereof is changed. The optical path-changing unit 130 changes the direction of propagation of light through scattering, diffraction, etc. Then, among light whose paths are changed, light having an incident angle that is smaller than the critical angle is transmitted through the light emitting surface 115 to be discharged, and remaining light is reflected again. Paths along which the reflected light travels are changed by the optical path-changing unit 130, such that the reflected light is again incident on the light emitting surface 115. As the optical path-changing unit 130, for example, a scattering pattern which scatters light or a holographic pattern which diffracts light can be used. The optical path-changing unit 130 can be disposed on either or both of the light emitting surface 115 and the top surface 114 opposite to the light emitting surface 115. In the exemplary embodiment shown in FIG. 3, as the optical path-changing unit 130, a holographic pattern on which a diffraction grating is formed in parallel to the light incident surface 112 is used.

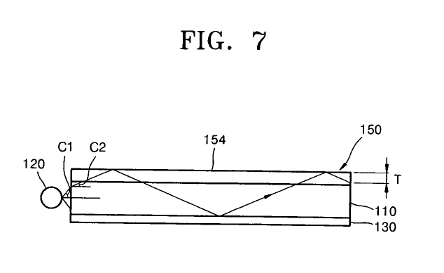

FIG. 6 and FIG. 7 are a plan view and a side view, respectively, for explaining the operation of the edge-light type backlight system according to an exemplary embodiment of the present invention. The CCFL 120 can be considered as a continuum of point light sources as described above. For simplicity, FIG. 6 shows optical paths for only four light emitting points on the CCFL 120.

Referring to FIGS. 6 and 7, light radiated from the CCFL 120 enters into the light guide panel 110 through the light incident surface 112. The light radiated from the CCFL 120 has a direction angle A3 and an elevation angle C1 of about ±90 degrees. The light radiated from the CCFL 120 is refracted at the light incident surface 112, such that it has a direction angle A4 and an elevation angle C2 of about ±42 degrees. Inside the light guide panel 110, light incident on any surfaces at an angle greater than the critical angle undergoes repeated total reflection and propagates through the light guide panel 110.

The light is incident on the optical deflector 150 as shown in FIGS. 6 and 7. The light incident on the optical deflector 150 is reflected by the first surface 151 or the second surface 152, which are boundary surfaces between the optical deflector 150 and an external medium, for example, air. When the optical deflector 150 is made of a material having the same refractive index as the light guide panel 110, a critical angle of the optical deflector is the same as the critical angle of the light guide panel 110. Since the first surface 151 and the second surface 152 become more distant from each other as distance from the light incident surface 112 increases, the direction angle of light reflected on the first surface 151 and the second surface 152 is reduced. That is to say, the first surface 151 and the second surface 152 function to collimate light inside the light guide panel 110. Light propagating through the light guide panel 110 has an elevation angle C2 component as shown in FIG. 7. Since the third surface 154 is parallel to the light emitting surface 115, the light is totally reflected on the third surface 154 and propagates through the light guide panel 110.

Now, while referring to simulation results of the distribution of light emitted at the opposite surface 113 according to whether the optical deflector 150 is used or not, the effect of the backlight system according to the present invention will be explained. The light guide panel 110 used in the simulation has dimensions of 42.6 mm by 32 mm, and a thickness of 1 mm. The optical deflector 150 has a length of 42.6 mm.

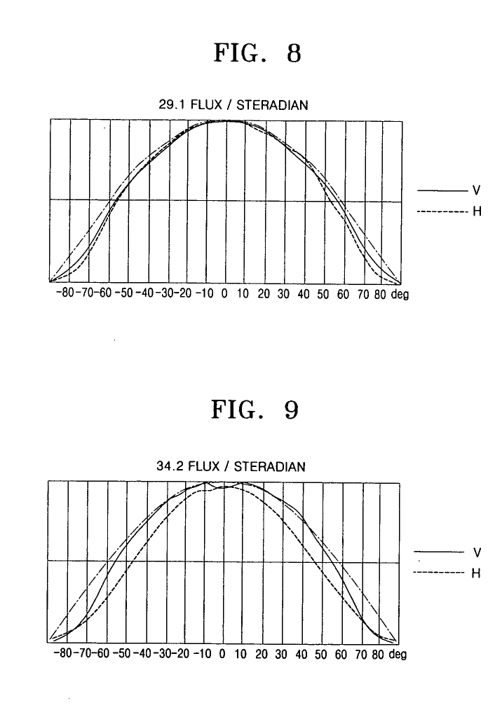

FIG. 8 is a graph illustrating the distribution of light emitted at an opposite surface 113 when the optical deflectors 150 are not used, according to a simulation.

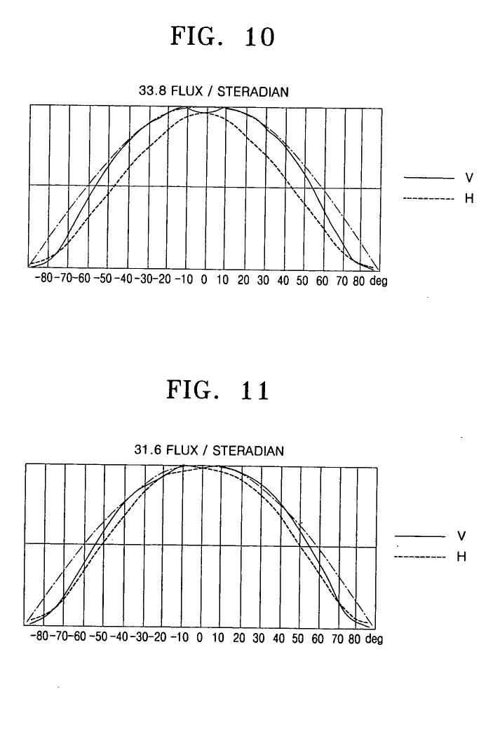

FIG. 9 and FIG. 10 show simulation results of the distribution of light emitted at the opposite surface 113 as the angle B1 between the first surface 151 of the optical deflectors and the normal line 116, and the angle B2 between the second surface 152 of the optical deflectors 150 and the normal line 116, are changed. FIG. 9 shows a case in which B1=B2=1°, and 20 optical deflectors 150 are arranged along the light incident surface 112, whereas FIG. 10 shows a case in which B1=B2=0.3°, and 64 optical deflectors 150 are arranged along the light incident surface 112. A thickness T of the optical deflector 150 is 0.2 mm.

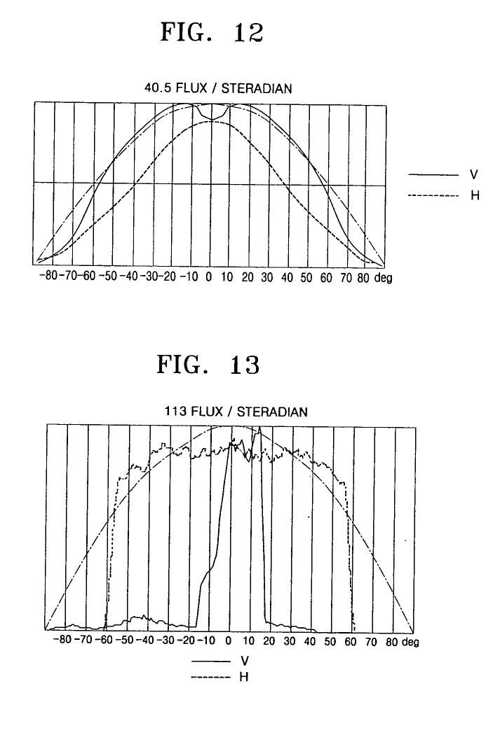

FIG. 11 and FIG. 12 are graphs illustrating the simulated distribution of light emitted at the opposite surface 113 when the thickness T of the optical deflectors 150 is 0.1 mm and 0.5 mm, respectively. The angle B1 between the first surface 151 and the normal line 116 and the angle B2 between the second surface 152 and the normal line 116 have the relationship B1=B2=1°. 20 optical deflectors 150 are installed along the light incident surface 112.

In the graphs of FIGS. 8 to 12, V and H represent the light distribution curves with respect to elevation angle C2 and the direction angle A2, respectively.

In the case of FIG. 8, a total flux of light emitted to the opposite surface 113 is 79.74, a flux/steradian is 29.1, and an angle at which intensity is full width half maximum (FWHM) is 55 degrees. In the case of FIG. 9, a total flux of light emitted to the opposite surface 113 is 80.33, a flux/steradian is 34.2, and FWHM is 48 degrees. In the case of FIG. 10, a total flux of light emitted to the opposite surface 113 is 79.74, a flux/steradian is 33.8, and the FWHM is 48 degrees. Referring to FIG. 11, a total flux of light emitted to the opposite surface 113 is 79.87, a flux/steradian is 31.6 and FWHM is 51 degrees. Referring to FIG. 12, a total flux of light emitted to the opposite surface 113 is 80.87, a flux/steradian is 40.5, and the FWHM is 38 degrees.

When FIGS. 9 and 10 are compared with FIG. 8, since the elevation angle C2 is not changed, the distribution of light emitted as the elevation angle C2 is changed has little change. However, the distribution of light emitted as the direction angle A4 is changed becomes considerably narrow, compared with FIG. 8. That is to say, since the direction angle A4 is reduced due to the collimation of the optical deflector 150, the total flux changes little but the flux/steradian and the FWHM are reduced.

Referring to FIGS. 9, 11 and 12, the thicker the optical deflector 160, the larger the total flux and the flux/steradian and the smaller the FWHM. Thus, when the angle B1 between the first surface 151 and the normal line 116 and the angle B2 between the second surface 152 and the normal line 116 are the same, the thicker the optical deflector 150, the greater its collimation effect.

In this way, light whose direction angle A4 is reduced by the optical deflector 150 experiences a change in its path because of the optical path-changing unit 130, such that light incident on the light emitting surface 115 at an angle smaller than the critical angle is transmitted through the light emitting surface 115 and the optical path-changing unit 130 to be discharged in the Z direction.

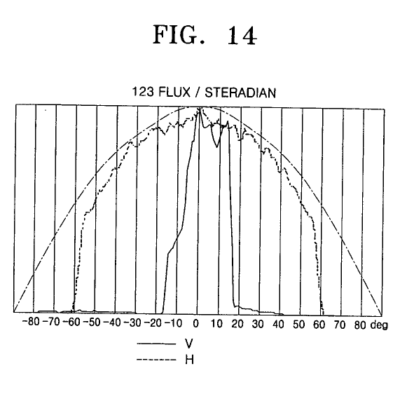

FIG. 13 is a graph illustrating the simulated distribution of light emitted from the light guide panel 110 when the optical deflector 150 is not used. FIG. 14 is a graph illustrating the simulated distribution of light emitted from the light guide panel 110 when the optical deflector 150 is used.

The light guide panel 110 used in the simulation has dimensions of 42.6 mm×32 mm×1 mm. The angle B1 between the first surface 151 of the optical deflector 150 and the normal line 116, and the angle B2 between the second surface 152 of the optical deflector 150 and the normal line 116, have the relationship B1=B2=1°. The thickness T of the optical deflector 150 is 0.2 mm.

In the graphs of FIGS. 13 to 14, V and H represent the light distribution curves with respect to the elevation angle C2 and the direction angle A4, respectively.

It can be seen from a dotted curve on the graph at the lower part of FIG. 13 that flux of light emitted from the light guide panel 110 is gently distributed over a wide range of angles (about ±65 degrees), and a flux/steradian is 113. In contrast, it can be seen from a dotted curve on the graph at the lower part of FIG. 14 that flux of light emitted from the light guide panel 110 is concentrated on and around 0 degrees, and a flux/steradian is 123. This means that when the optical deflector 150 is provided, the distribution of light emitted from the light guide panel 110 is narrowed and thus, a flux orthogonal to the light emitting surface 115 of the light guide panel 110 is increased.

In the edge-light type backlight system using the rod-shaped light source, the direction angle A4 of light inside the light guide panel 110 can be reduced by means of the optical deflector 150 which functions to collimate light. As a consequence, the optical path-changing unit 130 can change the path of light with a high efficiency, the flux/steradian of light emitted from the light guide panel can be increased, and the FWHM can be decreased. Accordingly, the angular distribution of light emitted from the light guide panel 110 is narrowed, thereby realizing uniform luminance on a screen of an FPD.

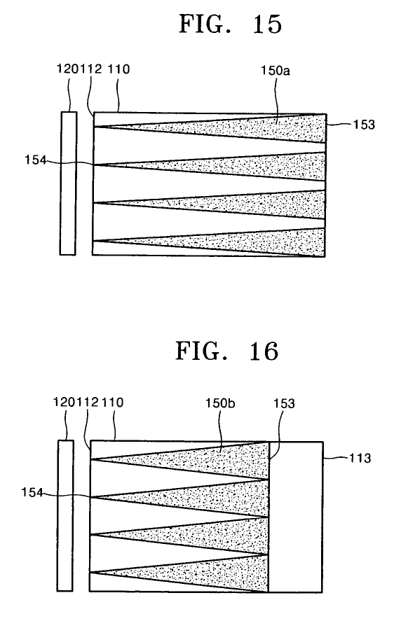

The edge-light type backlight system according to the present invention is not restricted by the above-described preferred embodiment, and various modifications can be made as shown in FIGS. 15 to 18.

Referring to FIG. 15, bottom surfaces of adjacent optical deflectors 150a are spaced apart from each other.

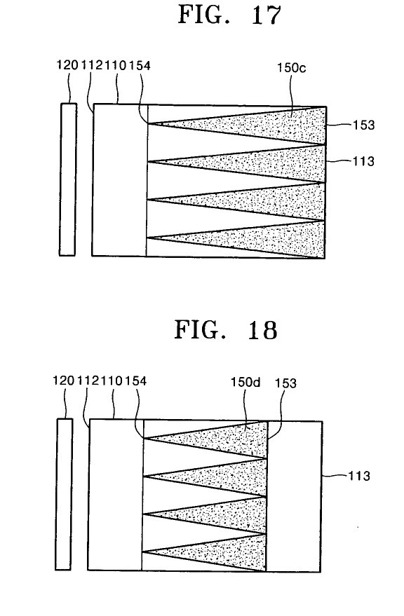

FIGS. 16 to 18 show modified optical deflectors 150 which are changed in length. FIG. 16 illustrates modified optical deflectors 150b whose apex 154 is in contact with the light incident surface 112 and bottom surface 153 is spaced apart from the opposite surface 113. FIG. 17 illustrates modified optical deflectors 150c whose apex 154 is spaced apart from the light incident surface 112 and bottom surface 153 is in contact with the opposite surface 113. FIG. 18 illustrates modified optical deflectors 150d whose apex 154 and bottom surface 153 are spaced apart from the light incident surface 112 and the opposite surface 113, respectively.

Further, when a plurality of optical deflectors are arranged, there is no need for the angle between the first surface of each optical deflector and the normal line orthogonal to the light incident surface to be the same as the angle between the second surface of each optical deflector and the normal line orthogonal to the light incident surface. Optical deflectors having various angles can be arranged to obtain a desired distribution of emitted light.

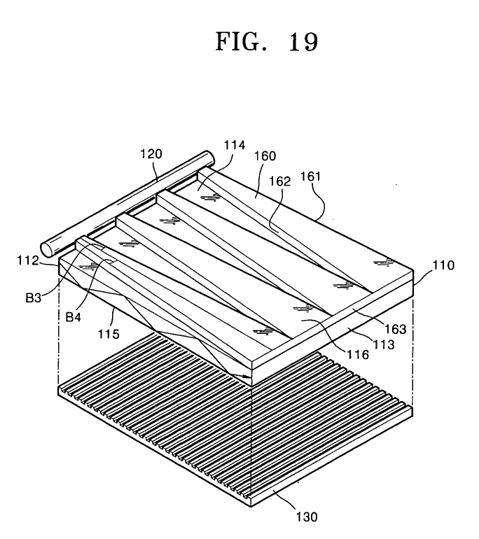

FIG. 19 is a perspective view of an edge-light type backlight system according to another exemplary embodiment of the present invention.

The exemplary embodiment of FIG. 19 is almost the same as the embodiment of FIG. 3, but a horizontal section of an optical deflector 160, namely, a cross-section in parallel to the light emitting surface 115, is in the shape of a trapezoid whose bottom surface 163 is directed toward the opposite surface 113. Furthermore, a vertical section of the optical deflector 160, namely, a cross-section in parallel to the light incident surface 112, is in the shape of a square. The distance between a first surface 161 and a second surface 162 increases as distance from the light incident surface 112 increases. Angles between the first and second surfaces 161 and 162 and the normal line 116 are B3 and B4, respectively. It is preferable that the first surface 161 and the second surface 162 are symmetrical about the normal line 116. In other words, the angle B3 between the first surface 161 and the normal line 116 and the angle B4 between the second surface 162 and the normal line 116 are identical to each other. In this case, a cross-section of the optical deflector 160 in parallel to the light emitting surface 115 is in the shape of an isosceles trapezoid. The operation and effect of the edge-light type backlight system of FIG. 19 will not be described since it is almost the same as that shown in FIGS. 3 through 14. Also, the edge-light type backlight system shown in FIG. 19 according to the present invention can be modified in the same way as shown in FIGS. 15 to 18. Additionally, when a plurality of optical deflectors are arranged, the angles between the first and second surfaces of the optical deflector and the normal line orthogonal to the light incident surface need not be identical to each other. Optical deflectors having various angles can be arranged to obtain a desired distribution of emitted light.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An edge-light type backlight system comprising:
a light guide panel including a light incident surface into which light enters and a light emitting surface from which light is emitted;
a rod-shaped light source which projects light to the light incident surface; and
a polyhedral optical deflector including a first surface and a second surface, the first surface and the second surface on opposite sides of a normal line orthogonal to the light incident surface and being more distant from each other as distance from the light incident surface increases,
wherein the optical deflector is disposed on at least one of the light emitting surface and a surface opposite to the light emitting surface.

2. The edge-light type backlight system of claim 1, wherein a plurality of optical deflectors are arranged along the light incident surface.

3. The edge-light type backlight system of claim 1, wherein the optical deflector has the same refractive index as the light guide panel.

4. The edge-light type backlight system of claim 1, wherein the optical deflector is integrally formed with the light guide panel.

5. The edge-light type backlight system of claim 1, wherein the first surface and the second surface are symmetrical about the normal line orthogonal to the light incident surface.

6. The edge-light type backlight system of claim 1, wherein the first surface and the second surface are extended up to a surface opposite to the light incident surface.

7. The edge-light type backlight system of claim 1, wherein the optical deflector further includes a third surface opposing the light emitting surface, and the third surface is parallel to the light emitting surface.

8. The edge-light type backlight system of claim 1, wherein a cross-section of the optical deflector in parallel to the light emitting surface is in the shape of a triangle whose oblique sides are the first and second surfaces and bottom side is opposite to the light incident surface.

9. The edge-light type backlight system of claim 1, wherein a cross-section of the optical deflector in parallel to the light emitting surface is in the shape of a trapezoid whose oblique sides are the first and second surfaces and bottom surface is opposite to the light incident surface.

10. A light guide panel of an edge-light type backlight system using a rod-shaped light source, the light guide panel comprising:
a light incident surface into which light enters;
a light emitting surface from which light is emitted; and
an optical deflector protruding from at least one of the light emitting surface and a surface opposite to the light emitting surface, a cross-section of the optical deflector in parallel to the light emitting surface being in the shape of a triangle whose bottom side is a surface opposite to the light incident surface, the triangular cross-section being extended in a direction perpendicular to the light emitting surface.

11. The light guide panel of claim 10, wherein a plurality of optical deflectors are arranged along the light incident surface.

12. The light guide panel of claim 10, wherein a cross-section of the optical deflector in parallel to the light emitting surface is in the shape of an isosceles triangle.

13. The light guide panel of claim 10, wherein the optical deflector further includes a third surface opposing the light emitting surface, and the third surface is parallel to the light emitting surface.

14. The light guide panel of claim 10, wherein the optical deflector is extended up to a surface opposite to the light incident surface.

15. A light guide panel of an edge-light type backlight system using a rod-shaped light source, the light guide panel comprising:
a light incident surface into which light enters;
a light emitting surface from which light is emitted; and
an optical deflector protruding from at least one of the light emitting surface and a surface opposite to the light emitting surface, a cross-section of the optical deflector in parallel to the light emitting surface being in the shape of a trapezoid whose bottom side is a surface opposite to the light incident surface, the trapezoid-shaped cross-section being extended in a direction perpendicular to the light emitting surface.

16. The light guide panel of claim 15, wherein a plurality of optical deflectors are arranged along the light incident surface.

17. The light guide panel of claim 15, -wherein a cross-section of the optical deflector in parallel to the light emitting surface is in the shape of an isosceles trapezoid.

18. The light guide panel of claim 15, wherein the optical deflector further includes a third surface opposing the light emitting surface, and the third surface is parallel to the light emitting surface.

19. The light guide panel of claim 15, wherein the optical deflector is extended up to a surface opposite to the light incident surface.
